(19) United States
(12) Patent Application Publication
(10) Pub. No.: US 2015/0228096 A1
(43) Pub. Date: Aug. 13, 2015

(54) DIRECTED GRAPH VISUALIZATION

(71) Applicant: INTERNATIONAL BUSINESS MACHINES CORPORATION, ARMONK, NY (US)

(72) Inventors: JAN RICHTER, MELBOURNE (AU); KENT CHARLES BARTON STEER, MELBOURNE (AU)

(73) Assignee: INTERNATIONAL BUSINESS MACHINES CORPORATION, ARMONK, NY (US)

(21) Appl. No.: 14/179,037

(22) Filed: Feb. 12, 2014

(51) Int. Cl. G06T 11/20; G06T 11/60

(52) U.S. Cl. CPC G06T 11/206; G06T 11/60

(57) ABSTRACT

A method for visualizing data represented by a graph includes receiving data represented as a directed graph that overlays a vector field upon the directed graph, where a vector of the vector field is associated with each vertex of the directed graph and forms an angle with an edge associated with said vertex, determining a threshold function for each edge with respect to the vector field, filtering from the directed graph all edges whose threshold function value with respect to the vector field is less than a predetermined threshold value; and visualizing the filtered directed graph.

### BACKGROUND

1. Technical Field

Embodiments of the present disclosure are directed to methods for visualizing data which is represented by a directed graph.

2. Discussion of the Related Art

The visualization of data which is associated with the edges of a directed graph is complicated by the fact that bidirectional edges correspond to two independent data points, but occupy the same physical ‘space’. A common solution is to visualize bidirectional edges as two unidirectional edges and offset these slightly, which is referred to as ‘split and offset’ technique. This allows the data point for each edge to be mapped to, for example, a pattern or color which can then be used to shade the edge. FIG. 1(a) is a directed graph with edges (a, b), (b, c), (b, d), (c, d), (d, c), and (e, d). FIGS. 1(b) and (c) respectively depict an example of the split and offset for bidirectional edges (c, d), (d, c), and an example of using different patterns (e.g., dashes and dots) for bidirectional edges (c, d), (d, c). While this technique allows the visualization to contain all the information, it does not always produce a useful visualization. For large, complex networks, a challenge is that there are so many edges that the ability to quickly gain some insight is lost, as there is too much visual clutter. Visualizations arising in traffic and transportation networks produce typical examples. In many cases, the user is not actually interested in all the data being presented, or not all of it is relevant. Currently, there exists no useful technique for filtering such data, or for augmenting it to a user's context.

### SUMMARY

According to an aspect of the disclosure, there is provided a method for visualizing data represented by a graph, including receiving data represented as a directed graph, overlaying a vector field upon the directed graph, where a vector of the vector field is associated with each vertex of the directed graph and forms an angle with an edge associated with the vertex, determining a threshold function for each edge with respect to the vector field, filtering from the directed graph all edges whose threshold function value with respect to the vector field is less than a predetermined threshold value and visualizing the filtered directed graph.

According to a further aspect of the invention, the threshold function is an angle between an edge (a, b) of the directed graph and a vector \vec{F}(x) in the vector field, where point x is associated with either starting vertex a or end vertex b of edge (a, b).

According to a further aspect of the invention, the predetermined threshold value depends on a magnitude of a vector associated with a point on an edge of the directed graph.

According to a further aspect of the invention, the predetermined threshold value is a function of a point in a space in which the vector field is defined.

According to a further aspect of the invention, the directed graph represents a road network, and edges of the graph are annotated with information including average speed, number of cars, road capacity, curvature, slope, and speed limit, and the annotated information is mapped into a range of an angle returned by the threshold function.

According to a further aspect of the invention, the vector field has a point source.

According to a further aspect of the invention, the road network represents an evacuation scenario, and the vector field has sinks that represent evacuation sites.

According to a further aspect of the invention, the edges are filtered by mapping the magnitude of the vector field into a threshold range.

According to a further aspect of the invention, the edges are filtered based on congestion, where congestion is determined by the average speed.

According to a further aspect of the invention, the vector field has a constant magnitude, and the vector field magnitude is the threshold value.

According to another aspect of the disclosure, there is provided a non-transitory program storage device readable by a computer, tangibly embodying a program of instructions executed by the computer to perform the method steps for visualizing data represented by a graph.

### BRIEF DESCRIPTION OF THE SEVERAL VIEWS OF THE DRAWINGS

FIGS. 1(a)-(c) show bidirectional edges in a directed graph, according to an embodiment of the disclosure.

FIG. 2 shows the angle between a directed edge and a vector field, according to an embodiment of the disclosure.

FIGS. 3(a)-(f) shows several examples of vector fields, according to an embodiment of the disclosure.

FIG. 4 is a flowchart of a process and components for filtering road link data, according to an embodiment of the disclosure.

FIG. 5 shows a vector-based filtering method applied to a set of directed edges in a uniform linear field with a threshold of 45 degrees, according to an embodiment of the disclosure.

FIG. 6 shows the same method applied to a set of connected edges, such as a road with lanes travelling in both directions, according to an embodiment of the disclosure.

FIG. 7 shows a field which varies in space such that the vector at each point in the field points towards the same central point, according to an embodiment of the disclosure.

FIG. 8 shows edges heading approximately towards the central point with a solid line, and others as dashes, according to an embodiment of the disclosure.

FIG. 9 is a block diagram of an exemplary computer system for implementing a method for visualizing data represented by directed graphs, according to an embodiment of the disclosure.

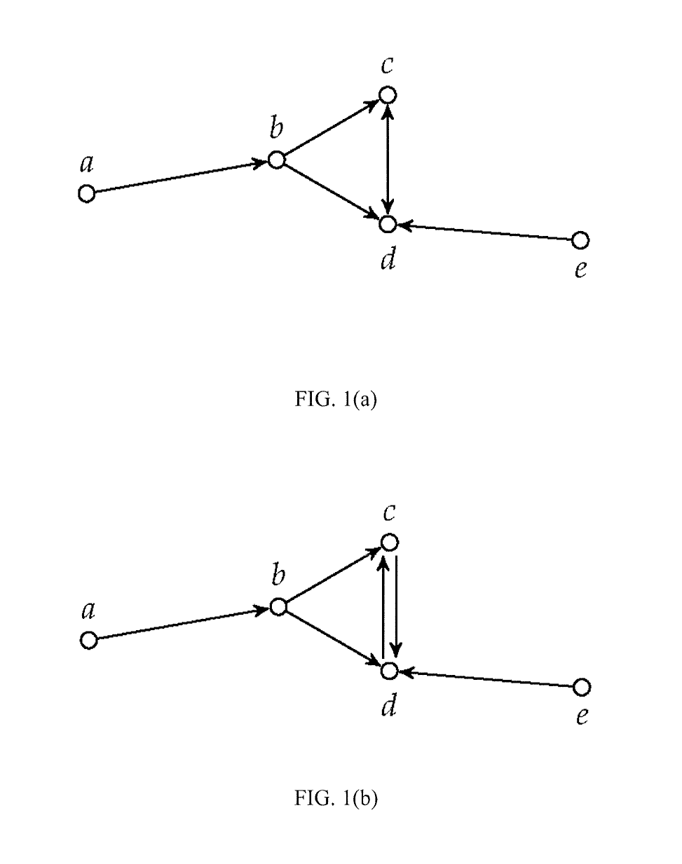

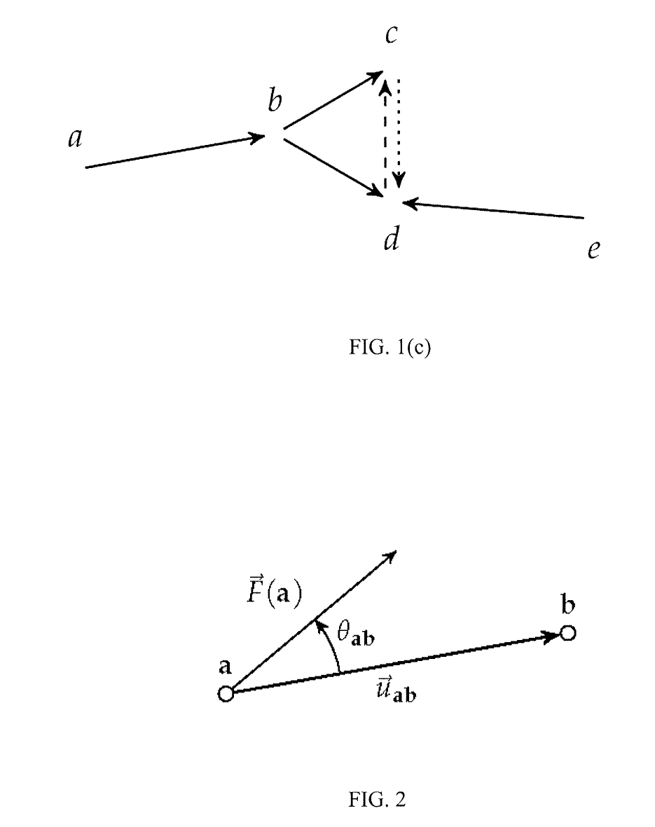

### DETAILED DESCRIPTION

Exemplary embodiments of the disclosure as described herein generally include systems and methods for visualizing data represented by directed graphs. Accordingly, while embodiments of the disclosure are susceptible to various modifications and alternative forms, specific embodiments thereof are shown by way of example in the drawings and will herein be described in detail. It should be understood, however, that there is no intent to limit embodiments of the disclosure to the particular forms disclosed, but on the contrary, embodiments of the disclosure cover all modifications, equivalents, and alternatives falling within the spirit and scope of the disclosure.

Embodiments of the disclosure provide a system and method for filtering edge-based data for visualization on directed graphs. Embodiments of the disclosure use a vector field to filter and augment the data which will be presented. This field characterizes information of interest and reduces visual clutter, as a user only sees relevant information. Insights can be gained more quickly and data transfer requirements are reduced.

According to an embodiment of the disclosure, a vector field can be used to express “what is interesting” as a function of space. The vector field is a useful way of describing this because, when looking at graphs, “what is interesting” is often related to the direction of the edges, and the position of those edges in space.

For example, given someone driving to home, which is 10 km to the west of their current location. This person is probably not interested in lanes travelling towards them, or even lanes running North and South from them. This person is primarily interested in lanes going towards their home (west). If this person is trying to view current traffic flow, they do not need to know about all those other roads that they are never going to use, just the ones that are roughly in the direction of their home. The vector field is just a way of expressing which roads might be useful to them, that when applied as a filter will remove visual clutter from the maps.

For simplicity of description and ease of human inspection, embodiments of the disclosure as disclosed herein are normally restricted to two dimensions, or three at most. However, an approach of filtering a directed graph using a vector field according to an embodiment of the disclosure can be applied in higher dimensional spaces, and may be useful for working with large complex data sets.

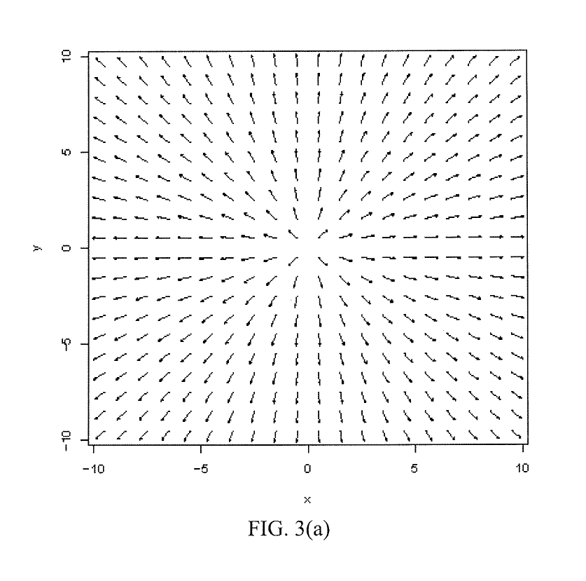

A directed graph comprises a set of vertices V and a set of directed edges E between the vertices. A directed edge is an ordered pair of vertices, i.e., (a, b), a, bεV. Let \vec{u}_{ab} be the vector connecting these vertices. A vector field is a function \vec{F} that assigns to each point x a vector given by \vec{F}(x). As such, the vector field defines a direction and magnitude for each point xεRⁿ. A Vector Field and a Directed Graph May be combined or overlaid so that a vector in the vector field can be associated with each vertex of the directed graph. FIG. 2 illustrates the angle between a directed edge (a, b) and a vector field at a. The cosine of the angle between two vectors may be found by dividing the dot product of the vectors by the product of their lengths. Thus, the cosine of the angle between an edge (a, b) and the field at a may be defined as:

$$cos {θ}_{ab} = \frac{{{u}^{->}}_{ab} \cdot {F}^{->} ( a )}{\vert {{u}^{->}}_{ab} \vert \cdot \vert {F}^{->} ( a ) \vert} . \qquad ( 1 )$$

In an approach according to an embodiment of the disclosure, every edge (a, b) for which |θ_{ab}|≦τ is rendered, where r is some threshold. That is, all edges for which |θ_{ab}|>τ are excluded. In this case, a threshold function is defined by

$${θ}_{ab} = {cos}^{- 1} \frac{{{u}^{->}}_{ab} \cdot {F}^{->} ( a )}{\vert {{u}^{->}}_{ab} \vert \cdot \vert {F}^{->} ( a ) \vert} .$$

The threshold value is thus used to determine whether a graph segment is displayed. If τ=π, then all segments are displayed and the visualization ‘looks’ the same as those produced by existing techniques.

### Filtering/Threshold Methods

In an alternative embodiment of the disclosure, the threshold τ depends on the magnitude of the vector at the point in the field space. For example, the threshold may increase with the distance from a point source, or vice versa. Similarly, the magnitude of each vector could map to the alpha channel of a graphics display, or may be a ‘display or not’ mechanism.

In another embodiment of the disclosure, the threshold τ varies depending on the space: τ=τ(x). As disclosed above, this could also be represented by the vector field in that the vector magnitude varies in space.

In another embodiment of the disclosure, the angle θ_{ab} may be mapped to the alpha channel of the graphics display so that edges which align with the vector field are fully opaque and those which differ are partially transparent in proportion to their difference.

In yet another embodiment of the disclosure, the point in the vector field for which a comparison vector is selected is based on an end point of the edge.

In another embodiment of the disclosure, the point in the vector field for which a comparison vector is selected is based on some other representative point or set of points of the edge.

The data to be filtered can be of any type of data associated with the edges of a graph. For example, if a graph represents a road network, the average speed, number of cars, or the capacity of the road are useful as congestion related measures. The edges of the road network may be annotated with the data for that particular edge, e.g. avg. speed, number of cars within a time interval, etc. This information is often shown using a color scale in a visualization (e.g., slow speed=red, fast speed=green). Such information can have a lower and upper bound, that is, a minimum and maximum speed for visualization, which can then be mapped (normalized) to the range of angles in the threshold function. For example, one exemplary, non-limiting mapping can be defined by θ=(speed.avg/speed.max) θₘₐₓ, with a threshold set to θₘᵢₙ=(speed.min/speed.max) θₘₐₓ.

Alternatively, the magnitude of the vector field can be used in the threshold function. For example, if at a region in the vector field the magnitude is X, and this is used to threshold the graph based on the average speed, then any graph edges in that region with an average speed below X will be removed, leaving only edges with speeds greater than X.

Traffic data is an exemplary, non-limiting example, and other information can be used depending on the context of the situation to be visualized. For example, the curvature, slope or speed limit of the roads can also be useful for trip planning, especially for certain kinds of vehicles such as trucks.

### Vector Fields

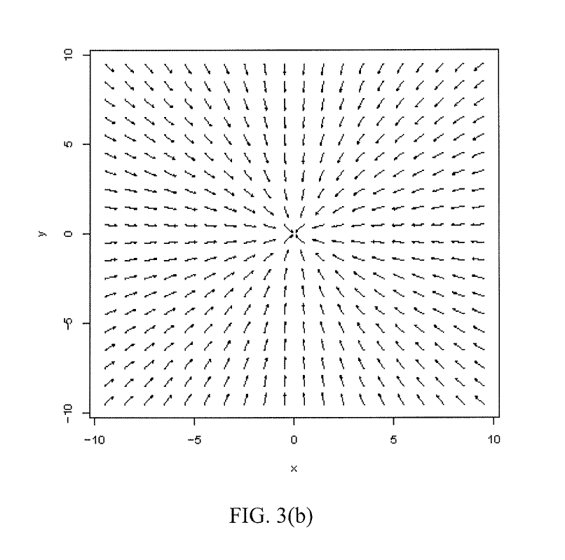

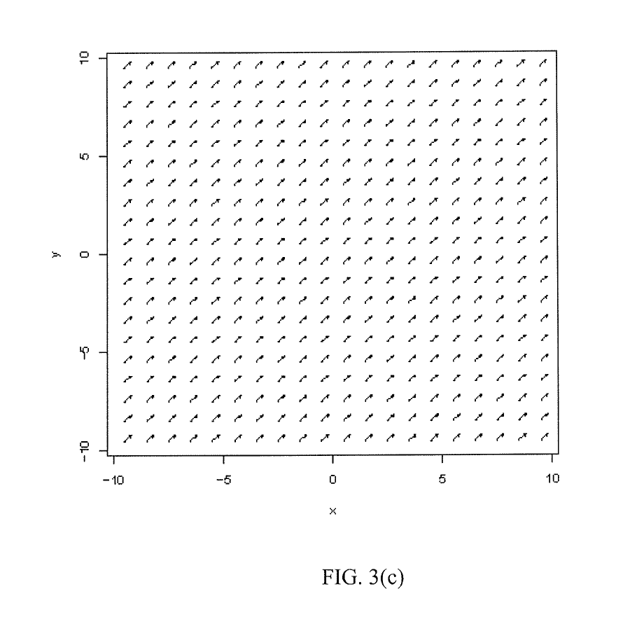

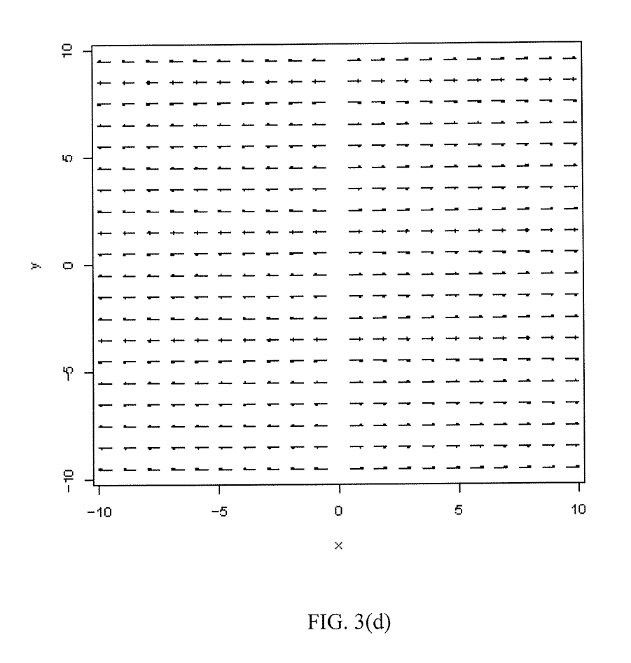

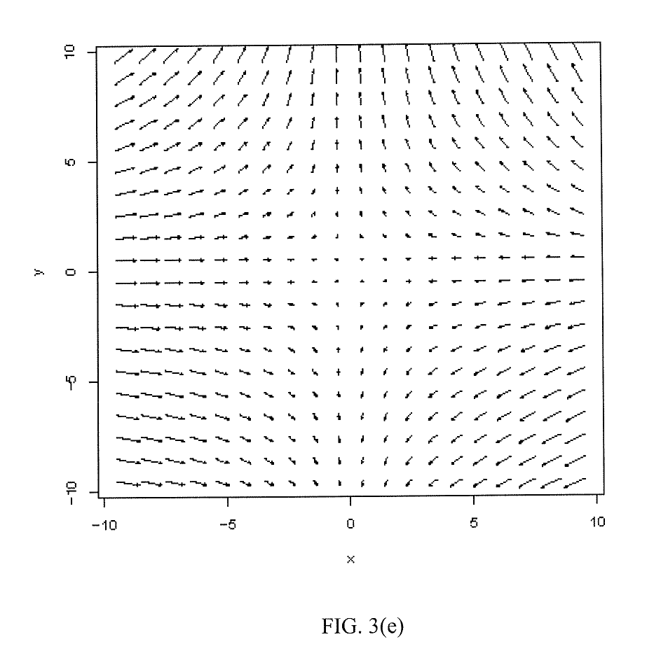

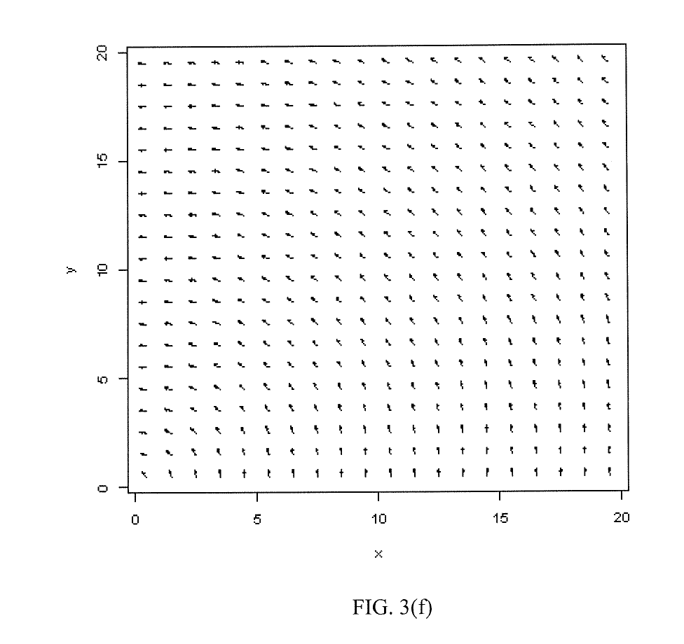

A vector field \vec{F}(x) and threshold τ characterize the interests of the user. Fields can be produced using single or multiple sinks or sources that may be of different shapes, such as a point or line segment. FIGS. 3(a)-(f) depicts several examples of vector fields. Fields can also have a uniform direction, east-west, as shown in FIG. 3(c). The examples shown in FIGS. 3(a)-(f) are exemplary and non-limiting, and there are infinitely many ways in which vector fields can be designed.

If the directed graph represents a road network, and the user is a driver interested in the traffic conditions, a field of vectors pointing away from the user's current location may be generated, also known as a point source, shown in FIG. 3(a). A threshold can be specified, e.g., π/2, that filters out all roads heading towards the current location. This leaves only those roads which the driver might use in his or her next trip.

Another example involving a road network may be a user selecting a location for a meeting of geographically distributed parties. For this situation a point sink field, shown in FIG. 3(b), maybe useful for restricting the visualization to only those roads heading towards candidate meeting locations.

When designing new major arterial links, a road planning engineer may be interested in all traffic flows heading north-east. In this case, a uniform field, such as that shown in FIG. 3(c), would be useful.

Traffic dispersion from a major road could be modeled by a linear source, such as that shown in FIG. 3(d).

An evacuation along a major road can be monitored by a field such as the one shown in FIG. 3(e), where all flows towards and along a major road are visible.

Finally, FIG. 3(f) shows a curved vector field that forms a quarter circle.

### Vector Field Creation Methods

According to an embodiment of the disclosure, a vector field creation tool can be developed to meet the needs of a given application. This can be as simple as choosing the location of sources and sinks for the field, or can be extended to allow control over the field strength, and to include a variety of alternate field types. At its core, a vector field comprises a set of equations which define the directions and strength of the field over a continuous space. The possibilities for the creation of user-specific vector fields are hence limitless, and can be generated by non-expert users given an above mentioned tool set. The field can also be generated in an entirely automatic way based on the users context, such as origin and destination locations. Such a tool, for example, could allow a user to set sink- and source locations via a clickable map, and adjust the strength and the directions via sliders for each of those as well as connect them to the targeted data for visualization.

### Filtering System

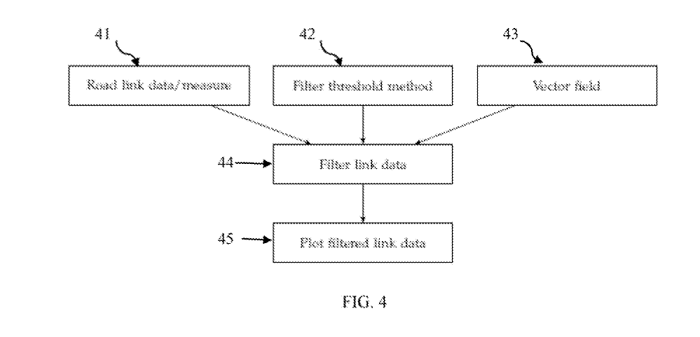

A system applying a filtering method according to an embodiment of the disclosure to a directed graph that represents a road network may use the components shown in FIG. 4. First, the underlying road link data or measure 41 to be visualized and filtered by the vector field needs to be specified. The measure can represent a combination of different information associated with links in the road network. The vector field 43 can be given by a user or generated interactively based on user input, e.g. a list of preferred origins, targets etc. The threshold 42 can be chosen based on the context of the problem or the user's interest. For example, the magnitude of the vectors may depend on the location of the road network, the user's preference, or other data inputs. Using the underlying road network and these filter components, the filter can be applied 44 to the road link data before it is plotted 45, using any of many different known methods of calculating a filter using different vector fields and thresholds.

### Example Scenarios

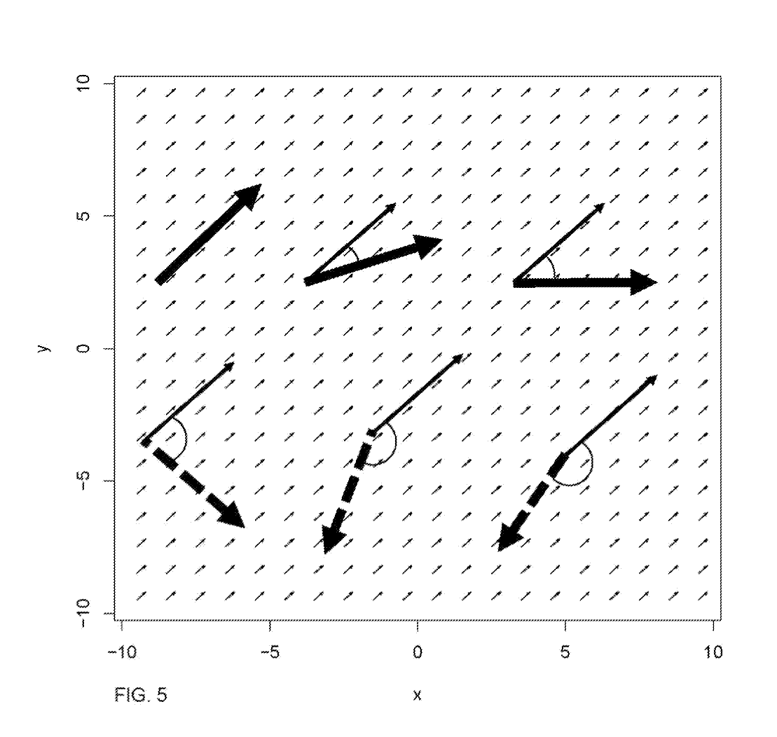

FIG. 5 shows a vector-based filtering method applied to a set of directed edges in a uniform linear field with a threshold of 45 degrees. Small background arrows show the direction of the field throughout the plane. Six example directed edges are shown. For each there is a thin arrow showing the direction of the field at the origin of the edge, a thick arrow showing the edge itself, and an arc showing the angle between the edge and the field. In this example, there is an exemplary, non-limiting threshold angle of 45 degrees. Those arrows in the top row are within the threshold, while those arrows in the bottom row exceed the threshold and are therefore shown as dashed lines. When a filtering approach according to an embodiment of the disclosure is applied, those dashed arrows that exceed the threshold would not be plotted.

Mapping the magnitude of vectors in the vector field to angles not only allows to filter data based on the angle between an edge and the vector field on that location, but also using the magnitude of the vector field in that location. For example, mapping the magnitude (large to small) to the threshold range of 45 to 180 degrees means that edge data is already filtered at smaller angles when the magnitude is large and vice versa. If the mapping of magnitude to angles was not used, the angle based filtering would be global across the whole network, only based on the direction of the vectors, instead of a local filtering using the magnitude at each location. Vectors with a lower magnitude are more tolerant to filtering links with a larger angle with respect to the vector field.

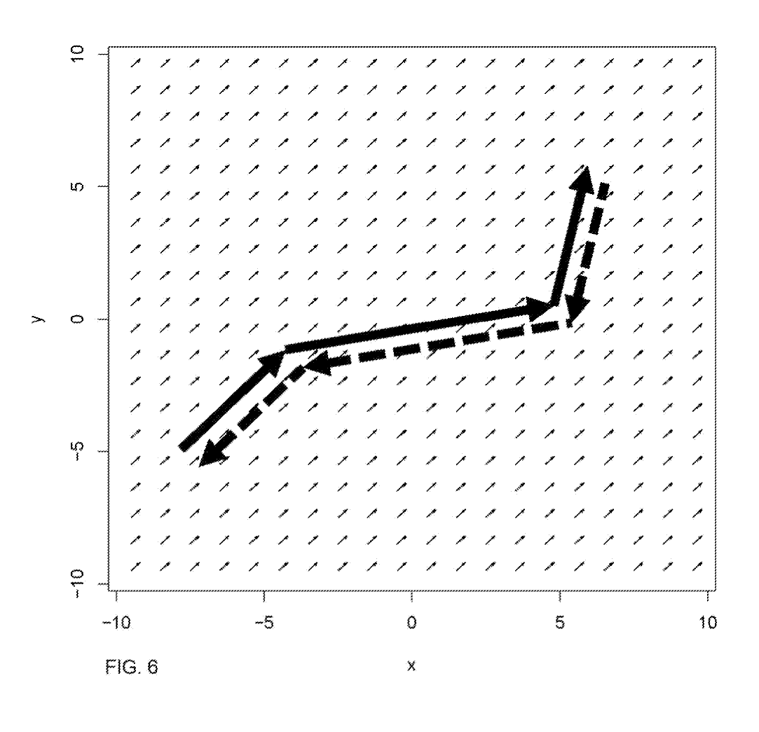

FIG. 6 shows the same method applied to a set of connected edges, such as a road with lanes travelling in both directions. The edges which travel in the direction of the field are shown as solid lines, while those travelling against the field are dashed. The applied filter would remove the dashed lines. Additional filters can be used to filter congested links. Congested links can be filtered using a traditional method, such as filtering roads with an average speed below 5 km/h. Congestion is expressed here in terms of average speed. Congestion does not have a single unit of measure, and so speed is often used as an approximation of congestion. Sometimes this is taken relative to the signed speed limit for a segment. A simpler vector field with uniform vector magnitudes could also be used to filter roads based only on their alignment. When only the alignment of vectors to edges is applied, an angle threshold needs to be specified beyond which the data is filtered. For example, if the threshold is 45 degrees then any edge which has a larger angle to the vector field at that location is not shown.

The vector magnitude can also be connected to an average speed instead of an angle threshold. The lower and upper boundaries for the magnitude can be mapped to an average speed interval.

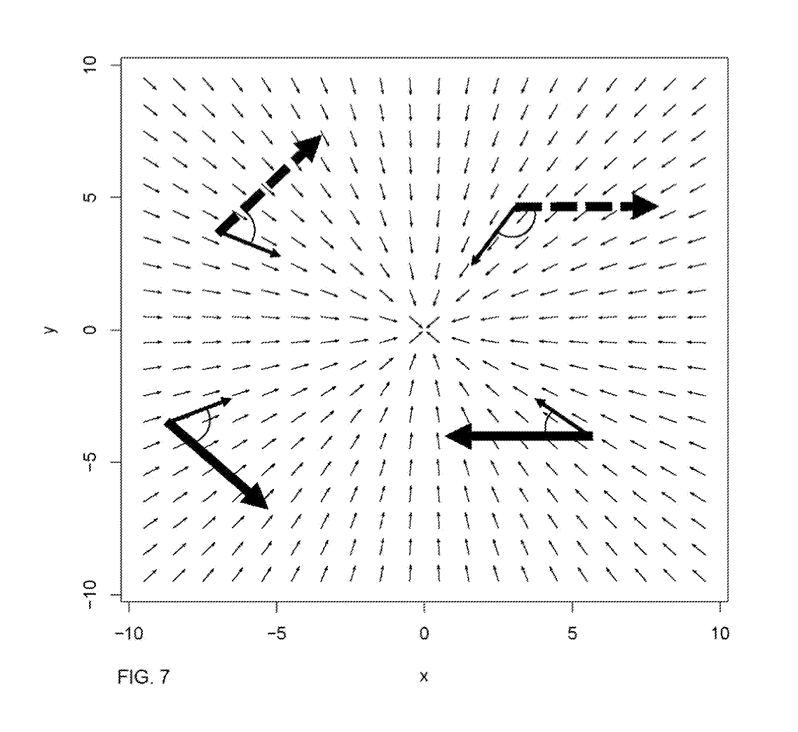

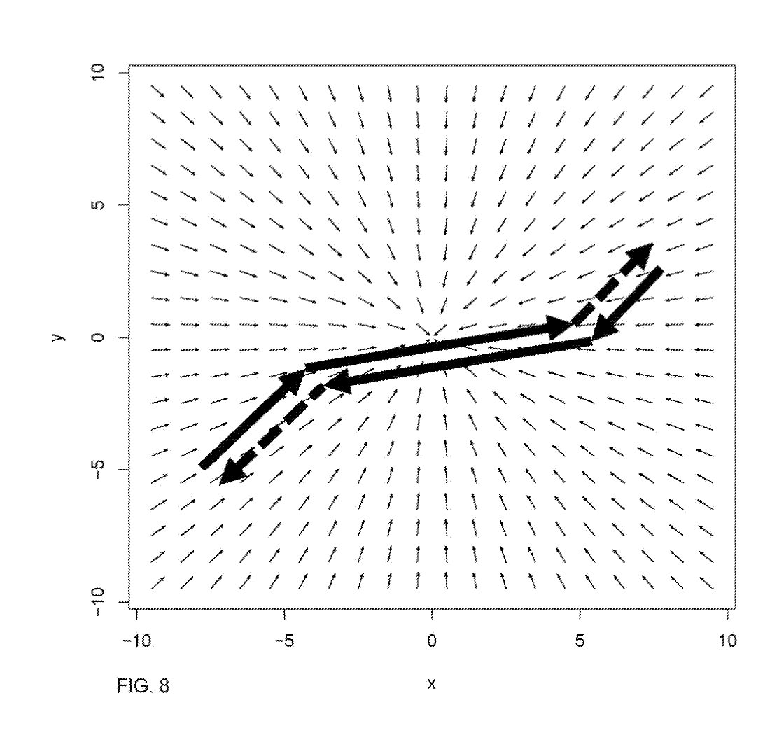

FIG. 7 shows a field which varies in space such that the vector at each point in the field points towards the same central point. Again, examples of directed edges are shown and the dashed lines are used to show those which do not meet the threshold. In FIG. 8, only edges heading approximately towards the central point are shown with a solid line; others are shown as dashes.

A vector-based filtering system according to an embodiment of the disclosure may also be used to visualize complex planning and operational decision situations. For example, in a simple evacuation scenario, the average speed for all paths can be shown that lead away from a point source specified in the vector field using a fixed angle threshold. After also filtering the congested roads, one may see possible evacuation sites that are outside of the evacuation radius, which is visualized by the vector magnitudes. Using a vector magnitude to drive the angle threshold of the filter allows one to see the connected links with lower congestion that are outside of the evacuation radius. Finally, applying a vector field with the evacuation sites included as point sinks (or targets), again with a fixed angle threshold with filtered congested links, can show those sites that have additional paths leading to them from the central evacuation therefore making them more accessible than other sites.

### System Implementations

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

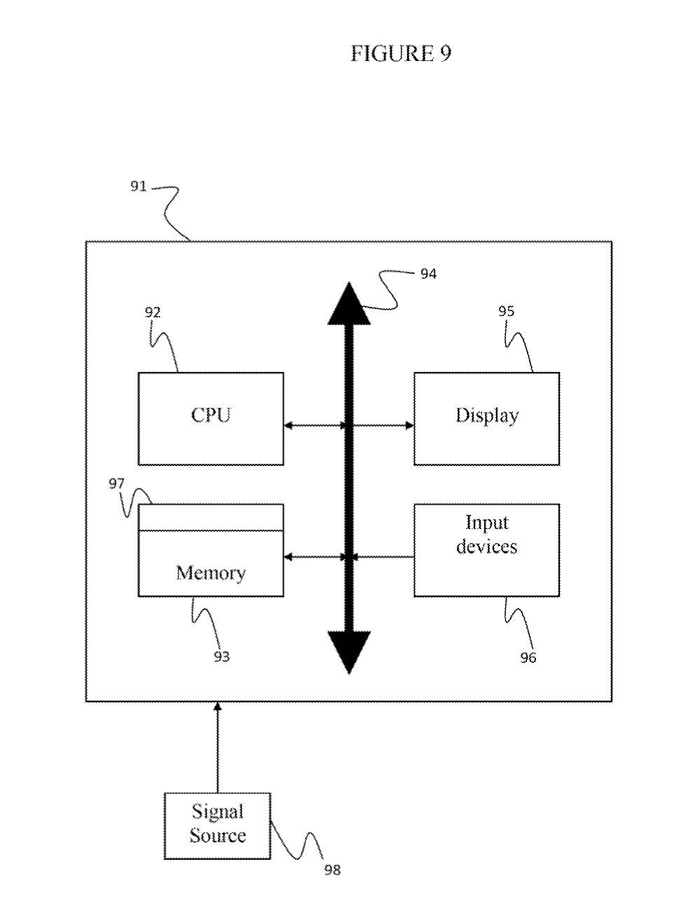

FIG. 9 is a block diagram of an exemplary computer system for implementing a method for predicting contract erosion and renewal risk ahead of contract expiration. Referring now to FIG. 9, a computer system 91 for implementing the present disclosure can comprise, inter alia, a central processing unit (CPU) 92, a memory 93 and an input/output (I/O) interface 94. The computer system 91 is generally coupled through the I/O interface 94 to a display 95 and various input devices 96 such as a mouse and a keyboard. The support circuits can include circuits such as cache, power supplies, clock circuits, and a communication bus. The memory 93 can include random access memory (RAM), read only memory (ROM), disk drive, tape drive, etc., or a combinations thereof. The present disclosure can be implemented as a routine 97 that is stored in memory 93 and executed by the CPU 92 to process the signal from the signal source 98. As such, the computer system 91 is a general purpose computer system that becomes a specific purpose computer system when executing the routine 97 of the present disclosure.

The computer system 91 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the present disclosure has been described in detail with reference to exemplary embodiments, those skilled in the art will appreciate that various modifications and substitutions can be made thereto without departing from the spirit and scope of the disclosure as set forth in the appended claims.

What is claimed is:

1. A method for visualizing data represented by a graph, comprising the steps of:
receiving data represented as a directed graph;
overlaying a vector field upon the directed graph, wherein a vector of said vector field is associated with each vertex of the directed graph and forms an angle with an edge associated with said vertex;
determining a threshold function for each edge with respect to the vector field;
filtering from the directed graph all edges whose threshold function value with respect to the vector field is less than a predetermined threshold value; and
visualizing the filtered directed graph.

2. The method of claim 1, wherein the threshold function is an angle between an edge (a, b) of the directed graph and a vector \vec{F}(x) in the vector field, wherein point x is associated with either starting vertex a or end vertex b of edge (a, b).

3. The method of claim 1, wherein the predetermined threshold value depends on a magnitude of a vector associated with a point on an edge of the directed graph.

4. The method of claim 1, wherein the predetermined threshold value is a function of a point in a space in which the vector field is defined.

5. The method of claim 2, wherein said directed graph represents a road network, and edges of said graph are annotated with information including average speed, number of cars, road capacity, curvature, slope, and speed limit, and the annotated information is mapped into a range of an angle returned by the threshold function.

6. The method of claim 5, wherein the vector field has a point source.

7. The method of claim 6, wherein said road network represents an evacuation scenario, and the vector field has sinks that represent evacuation sites.

8. The method of claim 5, wherein the edges are filtered by mapping the magnitude of the vector field into a threshold range.

9. The method of claim 8, wherein the edges are filtered based on congestion, wherein congestion is determined by the average speed.

10. The method of claim 1, wherein the vector field has a constant magnitude, and the vector field magnitude is the threshold value.

11. A non-transitory program storage device readable by a computer, tangibly embodying a program of instructions executed by the computer to perform the method steps for visualizing data represented by a graph, the method comprising the steps of:
receiving data represented as a directed graph;
overlaying a vector field upon the directed graph, wherein a vector of said vector field is associated with each vertex of the directed graph and forms an angle with an edge associated with said vertex;
determining a threshold function for each edge with respect to the vector field;
filtering from the directed graph all edges whose threshold function value with respect to the vector field is less than a predetermined threshold value; and
visualizing the filtered directed graph.

12. The computer readable program storage device of claim 11, wherein the threshold function is an angle between an edge (a, b) of the directed graph and a vector \vec{F}(x) in the vector field, wherein point x is associated with either starting vertex a or end vertex b of edge (a, b).

13. The computer readable program storage device of claim 11, wherein the predetermined threshold value depends on a magnitude of a vector associated with a point on an edge of the directed graph.

14. The computer readable program storage device of claim 11, wherein the predetermined threshold value is a function of a point in a space in which the vector field is defined.

15. The computer readable program storage device of claim 12, wherein said directed graph represents a road network, and edges of said graph are annotated with information including average speed, number of cars, road capacity, curvature, slope, and speed limit, and the annotated information is mapped into a range of an angle returned by the threshold function.

16. The computer readable program storage device of claim 15, wherein the vector field has a point source.

17. The computer readable program storage device of claim 16, wherein said road network represents an evacuation scenario, and the vector field has sinks that represent evacuation sites.

18. The computer readable program storage device of claim 15, wherein the edges are filtered by mapping the magnitude of the vector field into a threshold range.

19. The computer readable program storage device of claim 18, wherein the edges are filtered based on congestion, wherein congestion is determined by the average speed.

20. The computer readable program storage device of claim 11, wherein the vector field has a constant magnitude, and the vector field magnitude is the threshold value.
